(19) United States
(12) Patent Application Publication
(10) Pub. No.: US 2026/0163864 A1
(43) Pub. Date: Jun. 11, 2026

(54) DETECTING AND BLOCKING DIRECT-TO-IP EVASION TECHNIQUES

(71) Applicant: Fortinet, Inc., Sunnyvale, CA (US)

(72) Inventor: Victor Weis, Dayton, OH (US)

(73) Assignee: Fortinet, Inc., Sunnyvale, CA (US)

(21) Appl. No.: 18/969,489

(22) Filed: Dec. 5, 2024

(51) Int. Cl. H04L 9/40

(52) U.S. Cl. CPC H04L 63/0236

(57) ABSTRACT

Blocking a Direct-to-IP security evasion technique includes receiving a web request, by a network security appliance, from a requester over a network, the web request including a destination Internet Protocol (IP) address; checking, by the network security appliance, a domain name server (DNS) cache for the destination IP address; and in response to the destination IP address not being found in the DNS cache, blocking a connection for the web request by the network security appliance.

### BACKGROUND

Various embodiments of the present disclosure generally relate to computer networks and computing systems. In particular, embodiments relate to detecting and blocking certain security evasion techniques in a computing system.

Direct to Internet Protocol (IP) address (Direct-to-IP) communication refers to any network connection made to an IP address that has not been resolved through a Domain Name System (DNS). Normally, most legitimate applications use DNS to resolve domain names to IP addresses, which gives a DNS filtering system visibility into the fully qualified domain name (FQDN) of the destination host server, making it possible to block connections to malicious FQDNs. Attackers try to evade these DNS filtering controls by using Direct-to-IP communications for various nefarious purposes.

### SUMMARY

Systems and methods are described for improving computing system security technology in the context of computer networking. The present disclosure describes methods for detecting and blocking direct-to-IP connections to thwart evasion techniques and force attackers to revert to DNS, revealing their attack patterns, and allowing for traditional DNS filtering. Even if the DNS filter can't block the attack (e.g., if an attacker uses a domain name that is allowed by the DNS filter) there is at least the possibility to log the domain names to enhance threat hunting by discovering new Indicators of Compromise (IOCs).

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a computing environment according to an embodiment of the present disclosure.

FIG. 2 illustrates detecting and blocking direct-to-IP evasion techniques according to an embodiment of the present disclosure.

FIG. 3 illustrates allowing access to a requested web page according to an embodiment of the present disclosure.

FIG. 4 illustrates preventing an arbitrary resolver evasion technique processing according to an embodiment of the present disclosure.

FIG. 5 illustrates allowing access to a requested web page according to an embodiment of the present disclosure.

FIG. 6 illustrates detecting and blocking direct-to-IP evasion techniques processing according to an embodiment of the present disclosure.

FIG. 7 illustrates preventing an arbitrary resolver evasion technique according to an embodiment of the present disclosure.

FIG. 8 illustrates an example computing system in which or with which embodiments of the present disclosure may be utilized.

### DETAILED DESCRIPTION

Embodiments of the technology disclosed herein improve the security processing in a computer networking environment by detecting and blocking Direct-to-IP attacks.

Direct-to-IP communication refers to any network connection made to an IP address that has not been resolved through DNS (the Domain Name System). Normally, most legitimate applications use DNS to resolve domain names to IP addresses, which gives a DNS filter visibility into the connection, making it easy to block malicious connections.

Malicious actors (referred to herein generally as attackers) often try to evade DNS filtering controls of a firewall by using Direct-to-IP communications. Various attack strategies are known. For example, an insider attacker with direct physical access to a computing system might use one or more previously identified direct IP addresses (e.g., in the format nnn.nnn.nnn.nnn) to gain persistence for a remote access tool (RAT). A malware downloader might have a list of hard-coded IP addresses from which to retrieve additional payloads. Botnet trojans might have a list of hard-coded IPs for command and control (C2) servers. Peer-to-peer (P2P) worm malware might try to directly spread to IP addresses within target ranges. Spamming and denial of service (DOS) malware might also spam and attempt DoS attacks on direct IP addresses. Any form of malware might use surreptitious DNS resolution, using tunnels, proxies, non-standard ports, or other evasion techniques to evade a DNS filter.

When Direct-to-IP traffic is used, the firewall's DNS filter is unable to inspect for malicious DNS requests, because there is no DNS request. In this scenario, the DNS filter will allow all connections, including, for example, connections to malicious web sites.

A system for blocking direct-to-IP connections would thwart these evasion techniques and force the attackers to revert to DNS, revealing their attack patterns, and allowing for traditional DNS filtering. Even if the DNS filter is not able to block the attack (e.g., if the attacker uses a domain name that is allowed by the web filter) there is at least now the possibility to log the domain names to enhance threat hunting and discovering new IOCs.

Embodiments disclosed herein include methods for monitoring all DNS queries that are sent from client computing systems on a network and successfully resolved by a DNS server to one-or-more specific IP address (since some A/AAAA records may have multiple IP resolutions for load-balancing or geographic steering purposes). The system described herein stores these IP addresses in a data structure (such as a look-up table, which may be part of a DNS cache as described below), for at least the duration of the time-to-live (TTL) of the record and allows connections to be made to those IP addresses. The present system simultaneously disallows connections made to IP addresses that are not in the look-up table (e.g., in the DNS cache), since these are Direct-to-IP connections which may be malicious.

Some might propose using an integration between a network firewall and a third-party DNS server to build such a system, but this has several downsides that render this approach impractical. First, such an integration introduces undesirable latency for each DNS check, thus increasing the risk of false positives. Some DNS-resolved connections (which should be allowed) may time out waiting on a response from the application programming interface (API) with the DNS server to check if the destination IP had been previously resolved by a legitimate request. Furthermore, there will always be some discrepancy between the TTL of the record cached in the DNS server versus the TTL of the record cached by the client computing systems, where the cached record on the server will timeout some number of seconds before the same record times out on the client computing system's cache. During these moments, the client computing system may make a legitimate connection based off its cached record which would appear as if it were a Direct-to-IP connection to such a firewall-to-DNS-server integration system, since the server will no longer have this record cached.

Instead, if a system for blocking Direct-to-IP connections is to be effective, the system must integrate firewalling, DNS filtering, and DNS caching functionality natively within the same system, to minimize control plane latency to reduce false positives as much as possible. Furthermore, the system should allow for intelligent extensions to the TTLs of cached records by some number of seconds to account for client-side TTL discrepancies to further reduce false positives.

Furthermore, a system for blocking Direct-to-IP attacks must be able to block evasion techniques that involve an artificial resolver that returns arbitrary IP resolution on demand. For example, imagine an attacker sets up a DNS resolver system that will return the IP address “w.x.y.z” in response to the query “w.x.y.z.evader.example.com” (where w, x, y, and z are each an octet in the IPv4 system). If such an evasion technique were to be allowed, this would leave the system vulnerable to evasion by attackers. Therefore, the system should inspect for and be able to block DNS queries that contain an IPv4 address within them (e.g., as a substring).

Additionally, the use of encrypted DNS systems, such DNS-over-transport layer security (TLS) are becoming increasingly common, so the system should also be able to accommodate encrypted DNS methods, including DNS-over-TLS, and must be extendable to other encrypted DNS methods over time. This requires the use of TLS decryption to be available in this system for decrypting encrypted DNS queries.

Lastly, the system should acknowledge that some uses of Direct-to-IP might be necessary to be allowed, even though this is not a typical practice. There may exist at times desirable applications that use hard-coded IP addresses, and it may be infeasible to reconfigure these applications to use DNS resolution. Therefore, this system must give system administrators the flexibility to make exceptions on a case-by-case basis.

In the following description, numerous specific details are set forth to provide a thorough understanding of embodiments of the present disclosure. It will be apparent, however, to one skilled in the art that embodiments of the present disclosure may be practiced without some of these specific details. In other instances, well-known structures and devices are shown in block diagram form.

Brief definitions of terms used throughout this application are given below.

A “computer”, “computer system” or “computing system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” or a “computing system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform one or more network functions. Other network devices may also include custom hardware (e.g., one or more custom (ASICs)). Based upon the disclosure provided herein, one of ordinary skill in the art will recognize a variety of network appliances that may be used in relation to different embodiments.

As used herein, a “network security appliance” (NSA) refers to a network appliance or network device that performs security processing operations (such as a firewall, for example), and a virtual machine network security appliance (VMNSA) refers to a NSA implemented in software running in a processor of a computing system.

As used herein, the phrases “network path”, “communication path”, or “network communication path” generally refer to a path whereby information may be sent from one end and received on the other. In some embodiments, such paths are referred to commonly as tunnels which are configured and provisioned as is known in the art. Such paths may traverse, but are not limited to traversing, wired or wireless communication links, wide area network (WAN) communication links, local area network (LAN) communication links, and/or combinations of the aforementioned. Based upon the disclosure provided herein, one of ordinary skill in the art will recognize a variety of communication paths and/or combinations of communication paths that may be used in relation to different embodiments.

The phrases “processing resource” and “processing circuitry” are used in their broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

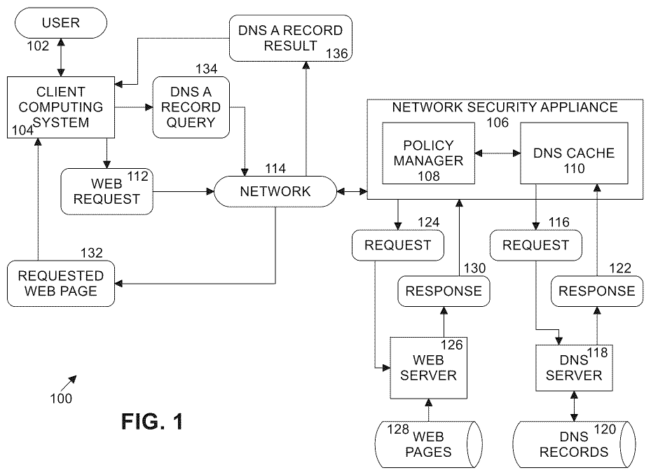

FIG. 1 illustrates a computing environment 100 according to an embodiment of the present disclosure. Computing environment 100 includes a network security appliance 106 coupled to a network (such as the Internet). Network security appliance 106 (e.g., a firewall) provides security protections for requested accesses to web server 126 hosting web pages 128. In an embodiment, network security appliance 106 may include at least policy manager 108 and DNS cache 110. Policy manager 108 provides network security policy management services for web server 126. In some cloud computing environments, there may be many network security appliances 106 and web servers 126 (e.g., a server farm).

In an embodiment, policy manager 108 and/or DNS cache 110 may be included in an operating system (OS) (such as FortiOS, available from Fortinet, Inc.) or network security appliance (NSA) 106 or may be a standalone software or hardware module in a computing system. For example, policy manager 108 and/or DNS cache 110 may be included in any virtual machine that performs processing of data for security and/or computer networking purposes. Such purposes may include, but are not limited to, authentication, next-generation firewall protection, anti-trojan scanning, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Security (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Based upon the disclosure provided herein, one of ordinary skill in the art will recognize a variety of security processes that may be implemented in accordance with different embodiments. In some embodiments, policy manager 108 and/or DNS cache 110 may be a virtual implementation of a known network security appliance 106 including, but not limited to, network gateways, virtual private network (VPN) appliances/gateways, unified threat management (UTM) appliances (e.g., the FORTIGATE family of network security appliances available from Fortinet, Inc.), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

Some existing operating systems of an NSA, such as the FortiOS system, already have robust firewalling and DNS filtering capabilities, as well as DNS caching, not only from the system's own recursive DNS server, but also from the system's DNS helper. DNS cache 110 (which sometimes may be implemented within the OS) maintains a comprehensive list of IP addresses that have been resolved by a DNS query traversing through a firewall (e.g., network security appliance 106), including queries made using DNS-over-TLS. By deduction, any connection attempts to any IP address not already within the DNS cache 110 are Direct-to-IP communication attempts that should be logged and/or blocked. Therefore, NSA 106 (e.g., including the OS) contains all the prerequisite ingredients to combine to form a robust system for blocking Direct-to-IP connections, while avoiding false positives.

In an embodiment, policy manager 108 and DNS cache 110 are running as two daemons within the same computing system (e.g., NSA 106), which allows for micro-second communication, which keeps latency to a minimum to reduce false positives. If an integration with an external DNS cache had been used instead, this would introduce much more latency (possibly on the order of milliseconds), which will introduce race conditions between the client's application-layer request versus the response from the external DNS caching server. Instead, embodiments of the present disclosure uniquely combine all these components within the same computing system (e.g., NSA 106).

Embodiments of the present disclosure introduce a method within NSA 106 to add a new feature and feature selection for firewall policies, where if this feature is enabled, policy manager 108 will check DNS cache 110 for a destination IP address that matches each new session traversing a network security policy, and if a matching destination IP is not found within the DNS cache, the policy manager will deny the connection. In an embodiment, the DNS cache may have a TTL grace period that can be configured to be several seconds longer than the default TTL of each record, to help reduce the possibility of false positives.

This system proposes a new command line interface (CLI) option for NSA 106 for each policy (e.g., “set block-direct-to-ip enable”) to enable this new feature. NSA 106 may accept a selection from a system administrator of the NSA to enable disable this feature. This system can also provide the option to log-but-not block, using a CLI option such as “set log-direct-to-ip enable.” NSA 106 may also accept a selection from a system administrator of the NSA to enable disable this feature. Furthermore, this system will also give control over TTL extensions with an option such as “set dns-cache-ttl-extend<integer>” where<integer> is some value in seconds between 0 and 86400, with a default value of 10. This will help reduce false positives due to client-side TTL discrepancies.

This feature may be implemented as a per-policy feature to make it easy for system administrators of NSA 106 to have granular control of when the feature should be used and to be able to make exemptions when needed.

Having this granular control, a system administrator of NSA 106 would be able to enable this feature in log-only mode for a selected period of time to see what kinds of systems are attempting Direct-to-IP communication and to investigate if there are any legitimate and approved use-cases that will need to be exempted from this feature. Then, the system administrator would be able to enable the Block Direct-to-IP feature for any non-approved use-cases of Direct-to-IP communications.

Additionally, to thwart the arbitrary resolver evasion technique, a new option may be added to a DNS filter profile in policy manager 108 that will block resolution of records of queries containing domain names including Internet Protocol version 4(IPv 4 ) addresses as a substring (“set block-direct-to-ip-evasion enable”). When this is enabled, the DNS filter performs a pattern matching check for sub-strings of the IPv4 format (“\d{1,3}\. \d{1,3}\. \d{1,3}\. \d{1,3}” in portal operating system interface (POSIX) notation).

In at least one attack scenario, user 102 uses client computing system 104 to send a web request 112 using a direct-to-IP approach over network 114 to web server 126. The web request is intercepted by NSA 106, which determines whether to allow the request 116 to web server 126 or deny the request. If the request is denied, no access to the requested web page is provided. If the request is allowed, request 116 may be sent to DNS server 118, a DNS A record is retrieved by DNS server 118 from DNS records 120 (e.g., corresponding to the domain of the requested web page), and response 122 is forwarded to DNS cache 110 of NSA 106. In an embodiment, the domain of the request is stored in DNS cache 110. Next, NSA 106 sends request 124 to web server 126 to obtain the requested web page from web pages 128. Response 130 is forwarded by NSA 106 over network 114 as requested web page 132 back to client computing system 104.

In an attack scenario where Direct-to-IP communication has been successfully prohibited by the above embodiments, client computing system 104 must use DNS resolution, which allows for successful DNS filtration. In this scenario, client computing system 104 sends a DNS A record query 134 over network 114 to DNS server 118. The DNS A record query is intercepted by NSA 106, which determines whether to allow the DNS A record query. If the DNS A record query is allowed, corresponding request 116 may be sent to DNS server 118, a DNS A record is retrieved from DNS records 120, and response 122 is forwarded over network 114 back to client computing system 104 as requested DNS A record result 136. If the DNS query is not allowed, NSA 106 may send a blocked portal webpage (or other security alert notification) to client computing system 104.

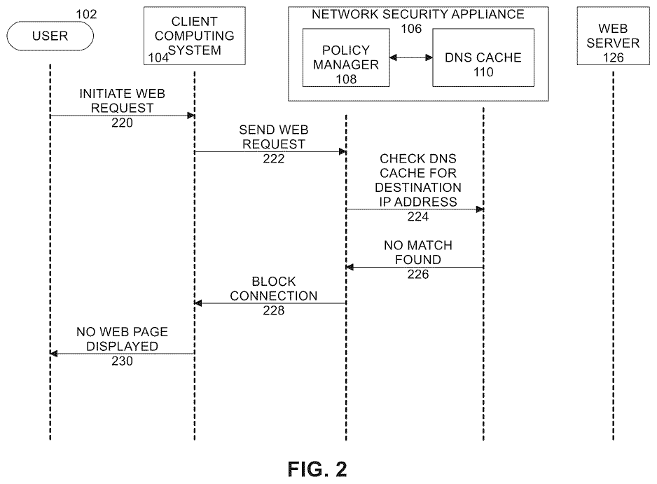

FIG. 2 illustrates detecting and blocking direct-to-IP evasion techniques according to an embodiment of the present disclosure. User 102 initiates a web request (which may or may not be legitimate) via arrow 220. Client computing system 104 sends web request 112 via arrow 222 to NSA 106. NSA 106 (e.g., using policy manager 108) checks DNS cache 110 for the destination IP address of web request 112. If no match is found, DNS cache 110 informs policy manager 108 via arrow 226 (e.g., the web request is assumed to be illegitimate). Policy manager 108 then denies the connection request for web request 112 and sends a block connection communication to client computing system 104 via arrow 228. As a result, no web page is displayed to user 102 by client computing system 104 via arrow 230. In an embodiment, an error message may be displayed.

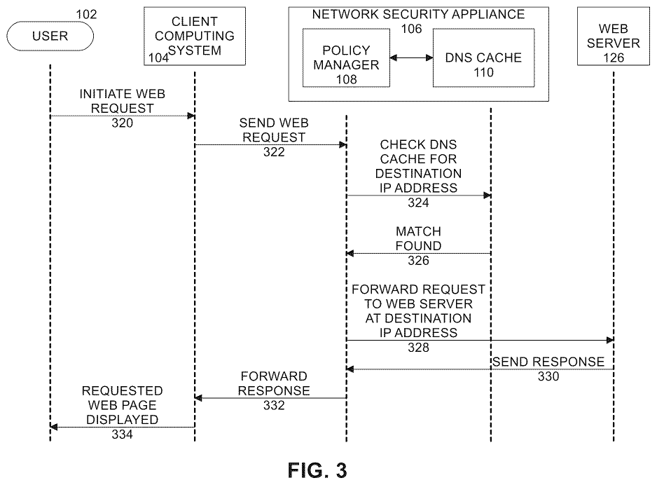

FIG. 3 illustrates allowing access to a requested web page according to an embodiment of the present disclosure. User 102 initiates a web request (which may or may not be legitimate) via arrow 320. Client computing system 104 sends web request 112 via arrow 322 to NSA 106. NSA 106 (e.g., using policy manager 108) checks DNS cache 110 for the destination IP address of web request 112. If a match is found, DNS cache 110 informs policy manager 108 via arrow 326 (e.g., the web request is assumed to be legitimate). Policy manager 108 then forwards web request 112 (e.g., as request 124) to web server 126 at the destination IP address via arrow 328. Web server 126 retrieves the requested web page 132 from web pages 128 and sends this response (e.g., response 130) to NSA 106 via arrow 330. NSA 106 forwards the response as requested web page 132 over network 114 to client computing system 104 via arrow 332. As a result, requested web page 132 is displayed to user 102 by client computing system 104 via arrow 334.

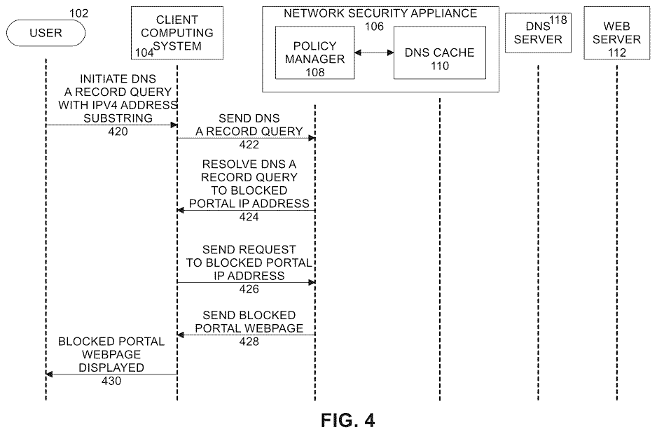

FIG. 4 illustrates preventing an arbitrary resolver evasion technique processing according to an embodiment of the present disclosure. User 102 initiates a DNS A record query 134 via arrow 420. In an example, the A record query includes a domain name including an IPv4 address substring (e.g., as part of an attempt to evade security policies of NSA 106). Client computing system 104 sends DNS A record query 134 via arrow 422 to DNS server 118. However, this DNS A record query is intercepted by NSA 106. NSA 106 detects the embedded IPv4 substring in the domain name, determines the embedded IPv4 substring is part of a security evasion technique to access a destination IP address and resolves the DNS A record query to a blocked portal IP address. NSA 106 sends the blocked portal IP address back to client computing system 104 via arrow 424. In response, client computing system 104 may send a web request 112 indicating the blocked portal IP address to web server 126 via arrow 426. This request is intercepted by NSA 106, which may send a blocked portal webpage (e.g., instead of the requested web page) back to client computing system via arrow 428. As a result, blocked portal webpage is displayed to user 102 by client computing system 104 via arrow 430. In an embodiment, the blocked portal webpage may include an error message.

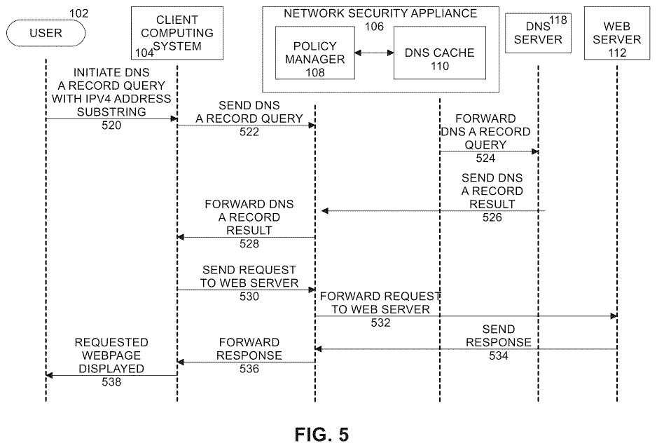

FIG. 5 illustrates allowing access to a requested web page according to an embodiment of the present disclosure. User 102 initiates a DNS A record query 134 via arrow 520. In this example, the A record query does not include an IPv4 address substring embedded in the requested destination IP address (e.g., as part of an attempt to evade security policies of NSA 106). Client computing system 104 sends DNS A record query 134 via arrow 522 to DNS server 118. This DNS A record query is also intercepted by NSA 106. In this example, NSA 106 does not detect an embedded IPv4 substring and forwards DNS A record query 134 (e.g., request 116) (using DNS cache 110) to DNS server 118 via arrow 524. DNS server 118 sends DNS A record result (e.g., response 122) to NSA 106 via arrow 526. NSA 106 forwards DNS A record result 135 over network 114 to client computing system via arrow 528. In response, client computing system 104 may send a web request 112 indicating the destination IP address from DNA A record result 136 to web server 126 via arrow 530. This request is intercepted by NSA 106, which forwards web request 112 (e.g., request 124) to web server 126 via arrow 532. Web server 126 retrieves the requested web page 132 from web pages 128 and sends response 130 to NSA 106 via arrow 534. NSA 106 forwards the response over network 114 to client computing system 104 via arrow 536. As a result, requested webpage 1132 is displayed to user 102 by client computing system 104 via arrow 538.

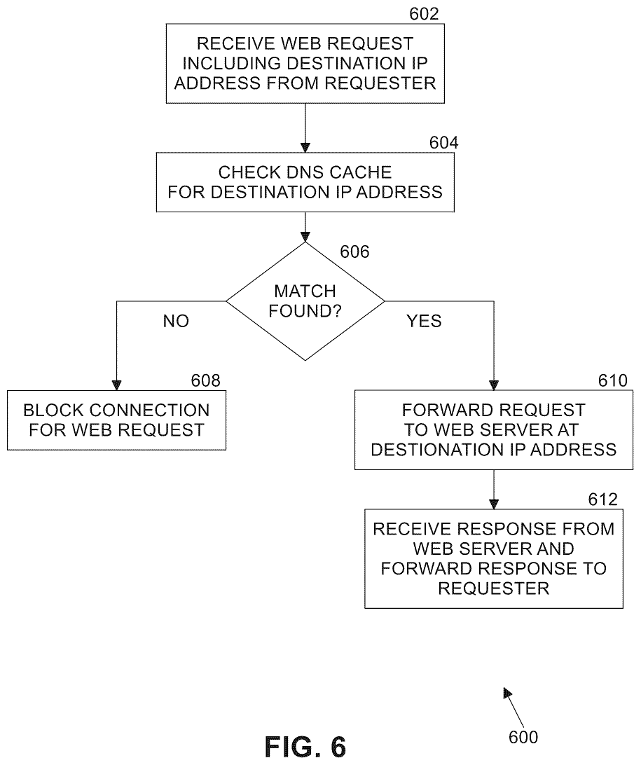

FIG. 6 illustrates detecting and blocking direct-to-IP evasion techniques processing according to an embodiment of the present disclosure. A detecting and blocking direct-to-IP evasion techniques process 600 begins with NSA 106 receiving a web request 112 including a destination IP address from a requester (such as client computing system 104) over network 114 at block 602. At block 604, NSA 106 (e.g., using policy manager 108) checks DNS cache 110 for the destination IP address. If no match is found at block 606, NSA 106 blocks the connection for web request 112 at block 608. In an embodiment, the destination IP address may be stored in a list of security evasion attempts for future security analysis. If a match is found at block 606, NSA 106 forwards the request 124 to web server 126 at the destination IP address at block 610. At block 612, NSA 106 receives a response 130 received from web server 126 and forwards the response (e.g., requested web page 132) to the requester.

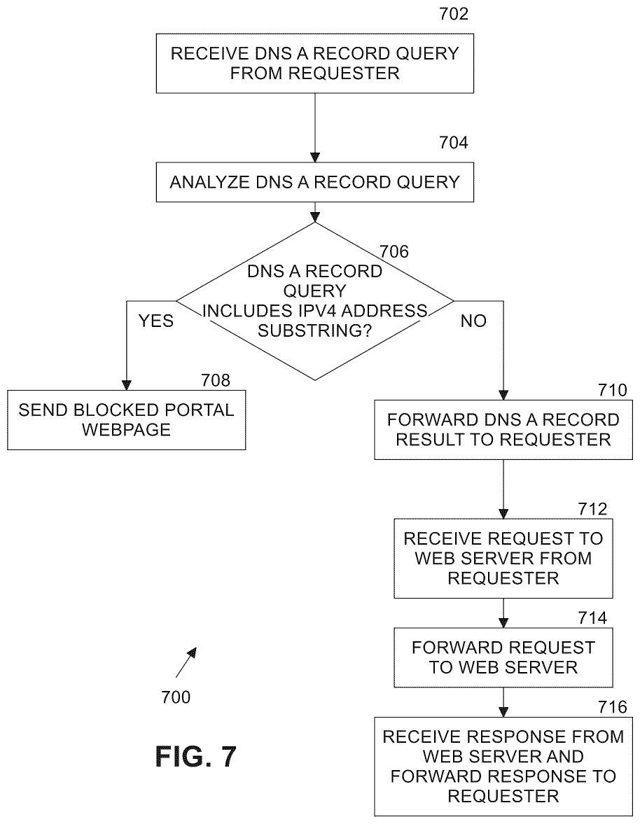

FIG. 7 illustrates preventing an arbitrary resolver evasion technique according to an embodiment of the present disclosure. A process 700 for preventing an arbitrary resolver evasion technique begins at block 702 with NSA 106 receiving a DNS A record query 134 from a requester (such as client computing system 104) over network 114. NSA 106 at block 704 analyzes the DNA A record query to determine if the DNS A record query includes a domain name including a destination IP address with an embedded IPv4 address substring. If the DNS A record query includes an embedded IPv4 address substring at block 706, then NSA 106 sends a blocked portal webpage back to the requester at block 708. In an embodiment, the domain name including the embedded IPv4 address substring may be stored for future security analysis. If the DNS A record query does not include a domain name with an embedded IPv4 address substring at block 706, NSA 106 gets the DNA A record result corresponding to the DNA A record query from DNS server 118 and forwards the DNS A record result to the requester at block 710. NSA 106 may then receive a web request 112 to web server 126 from the requester at block 712, the web request including the destination IP address returned in the DNS A record result at block 710. NSA 106 forwards the web page request to the web server 126 at block 714. NSA 106 receives the response from the web server and forwards the response (e.g., the requested web page) to the requester at block 716.

The technology of the direct-to-IP detecting and blocking processing system described herein provides at least several advantages and technical improvements over existing computer networking systems. Embodiments include the advantage of thwarting with high precision any attack pattern that includes Direct-to-IP DNS filter evasion techniques, which imposes significant extra costs on attackers, since they must now register public domain names for their attacks, and these malicious domain names can be blocked by DNS filtering systems once they are detected. Furthermore, embodiments have the advantage of foreseeing the arbitrary resolver evasion method that would otherwise defeat the efficacy of this embodiment.

While in the context of the example described with reference to the flow diagrams of this disclosure, a number of enumerated blocks are included, it is to be understood that examples may include additional blocks before, after, and/or in between the enumerated blocks. Similarly, in some examples, one or more of the enumerated blocks may be omitted and/or performed in a different order.

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the implementation, various steps may be performed by a combination of hardware, software, firmware and/or by human operators.

Embodiments of the present disclosure may be provided as a computer program product, which may include a tangible non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or general-purpose computer hardware to execute the code contained therein. An apparatus for practicing various embodiments of the present disclosure may involve one or more computer systems (e.g., physical and/or virtual servers, physical and/or virtual network security appliances) (or one or more processors within a single computer system) and storage systems containing or having network access to computer program(s) coded in accordance with various methods described herein, and the method steps associated with embodiments of the present disclosure may be accomplished by modules, routines, subroutines, or subparts of a computer program product.

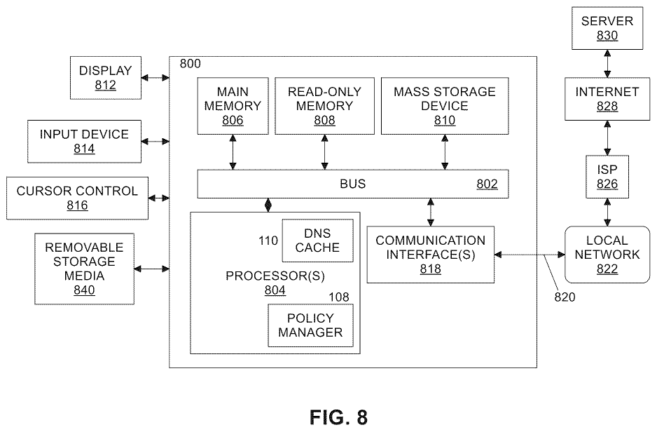

FIG. 8 illustrates an example computing system in which or with which embodiments of the present disclosure may be utilized. FIG. 8 shows a block diagram that illustrates a computing system 800 in which or with which an embodiment of the present disclosure may be implemented. Computing system 800 may be representative of a computer server (e.g., a cloud server in a cloud computing environment) or client computing system on which policy manager 108 is running. Notably, components of computing system 800 described herein are meant only to exemplify various possibilities. In no way should the example computing system 800 limit the scope of the present disclosure. In the context of the present example, computing system 800 includes a bus 802 or other communication mechanism for communicating information, and one or more processing resources (e.g., one or more hardware processors 804) coupled with bus 802 for processing information. Hardware processors 804 may include, for example, one or more general purpose microprocessors available from one or more current or future microprocessor manufactures (e.g., Intel Corporation, Advanced Micro Devices, Inc., and/or the like) and/or one or more special purpose processors (e.g., graphics processing units (GPUs), network processors (NPs), and/or accelerators or co-processors). In some examples, one or more processing resources may be part of an application specific integrated circuit (ASIC)-based security processing unit (e.g., the FORTISP family of security processing units available from Fortinet, Inc. of Sunnyvale, CA).

Computing system 800 also includes a main memory 806, such as a machine-readable random-access memory (RAM) or other dynamic storage device, coupled to bus 802 for storing information and instructions (e.g., policy manager 108 and/or DNS cache 110) to be executed by processor(s) 804. Main memory 806 also may be used for storing temporary variables or other intermediate information during execution of instructions to be executed by processor(s) 804. Such instructions, when stored in non-transitory storage media accessible to processor(s) 804, render computing system 800 into a special-purpose machine that is customized to perform the operations specified in the instructions.

Computing system 800 further includes a read only memory (ROM) 808 or other static storage device coupled to bus 802 for storing static information and instructions (e.g., policy manager 108 and/or DNS cache 110) for processor(s) 804. A storage device 810, e.g., a magnetic disk, optical disk or flash disk (made of flash memory chips), is provided and coupled to bus 802 for storing information and instructions.

Computing system 800 may be coupled via bus 802 to a display 812, e.g., a cathode ray tube (CRT), Liquid Crystal Display (LCD), Organic Light-Emitting Diode Display (OLED), Digital Light Processing Display (DLP) or the like, for displaying information to a computer user. An input device 814, including alphanumeric and other keys, is coupled to bus 802 for communicating information and command selections to processor(s) 804. Another type of user input device is cursor control 816, such as a mouse, a trackball, a trackpad, or cursor direction keys for communicating direction information and command selections to processor(s) 804 and for controlling cursor movement on display 812. The input device typically has two degrees of freedom in two axes, a first axis (e.g., x) and a second axis (e.g., y), that allows the device to specify positions in a plane.

Removable storage media 840 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computing system 800 may implement the techniques described herein using customized hard-wired logic, one or more ASICs or field programmable gate arrays (FPGAs), firmware or program logic which in combination with the computer system causes or programs computing system 800 to be a special-purpose machine. According to one embodiment, the techniques herein are performed by computing system 800 in response to processor(s) executing one or more sequences of one or more instructions (e.g., policy manager 108 and/or DNS cache 110) contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “storage media” as used herein refers to any non-transitory machine-readable media that stores data or instructions that cause a machine to operate in a specific fashion. Such storage media may comprise non-volatile media or volatile media. Non-volatile media includes, for example, optical, magnetic or flash disks, such as storage device 810. Volatile media includes dynamic memory, such as main memory 806. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor(s) 804 for execution. For example, the instructions may initially be carried on a magnetic disk or solid-state drive of a remote computer. The remote computer can load the instructions into its dynamic memory and send the instructions over a telephone line using a modem. A modem local to computing system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor(s) 804 retrieve and execute the instructions. The instructions received by main memory 806 may optionally be stored on storage device 810 either before or after execution by processor(s) 804.

Computing system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection. to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computing system 800, are example forms of transmission media.

Computing system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor(s) 804 as it is received, or stored in storage device 810, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
receiving a web request, by a network security appliance, from a requester over a network, the web request including a destination Internet Protocol (IP) address;
checking, by the network security appliance, a domain name server (DNS) cache for the destination IP address; and
in response to the destination IP address not being found in the DNS cache, blocking a connection for the web request by the network security appliance.

2. The method of claim 1, further comprising:
in response to the destination IP address being found in the DNS cache, forwarding, by the network security appliance, the web request to a web server at the destination IP address, receiving a response from the web server, and forwarding the response to the requester.

3. The method of claim 2, wherein the response comprises a web page.

4. The method of claim 1, wherein the network security appliance comprises a firewall.

5. The method of claim 1, further comprising accepting a selection from a system administrator of the network security appliance to enable the checking.

6. The method of claim 1, comprising storing the destination IP address in a list of security evasion attempts.

7. A non-transitory, machine-readable medium storing instructions, which when executed by one or more processing resources, cause the one or more processing resources to:
receive a web request, by a network security appliance, from a requester over a network, the web request including a destination Internet Protocol (IP) address;
check, by the network security appliance, a domain name server (DNS) cache for the destination IP address; and
in response to the destination IP address not being found in the DNS cache, block a connection for the web request by the network security appliance.

8. The non-transitory, machine-readable medium of claim 7, wherein the instructions further comprise instructions to:
in response to the destination IP address being found in the DNS cache, forward, by the network security appliance, the web request to a web server at the destination IP address, receive a response from the web server, and forward the response to the requester.

9. The non-transitory, machine-readable medium of claim 7, wherein the instructions further comprise instructions to accept a selection from a system administrator of the network security appliance to enable the checking.

10. A method comprising:
receiving a domain name server (DNS) A record query, by a network security appliance, from a requester over a network, the DNS A record query including a domain name;
determining, by the network security appliance, whether the domain name includes an Internet Protocol (IP) version 4 (IPv 4 ) address substring; and
in response to the domain name including an IPv4 address substring, sending a blocked portal webpage to the requester by the network security appliance.

11. The method of claim 10, further comprising:
in response to the domain name not including an IPv4 address substring,
getting a DNS A record result corresponding to the DNS A record query from a DNS server, the DNS A record result including a destination IP address corresponding to the domain name;
forwarding the DNS A record result over the network to the requester;
receiving a web request over the network from the requester;
forwarding the web request to a web server; and
receiving a response from the web server and forwarding the response over the network to the requester.

12. The method of claim 10, wherein the network security appliance comprises a firewall.

13. The method of claim 10, further comprising accepting a selection from a system administrator of the network security appliance to enable the determining.

14. The method of claim 10, further comprising storing the domain name including the IPv4 substring.

15. A non-transitory, machine-readable medium storing instructions, which when executed by one or more processing resources, cause the one or more processing resources to:
receive a domain name server (DNS) A record query, by a network security appliance, from a requester over a network, the DNS A record query including a domain name;
determine, by the network security appliance, whether the domain name includes an Internet Protocol (IP) version 4 (IPv 4 ) substring; and
in response to the domain name including an IPv4 substring, send a blocked portal webpage to the requester by the network security appliance.

16. The non-transitory, machine-readable medium of claim 15, wherein the instructions further comprise instructions to:
in response to the domain name not including an IPv4 substring,
get a DNS A record result corresponding to the DNS A record query from a DNS server, the DNS A record result including a destination IP address corresponding to the domain name;
forward the DNS A record result over the network to the requester;
receive a web request over the network from the requester;
forward the web request to a web server; and
receive a response from the web server and forward the response over the network to the requester.

17. The non-transitory, machine-readable medium of claim 15, wherein the network security appliance comprises a firewall.

18. The non-transitory, machine-readable medium of claim 15, wherein the instructions further comprise instructions to:
accept a selection from a system administrator of the network security appliance to enable the determining.

19. The machine-readable medium of claim 15, wherein the instructions further comprise instructions to:
store the domain name including the IPv4 substring.
